(19) United States
(12) Patent Application Publication
(10) Pub. No.: US 2013/0147650 A1
(43) Pub. Date: Jun. 13, 2013

(54) ELECTROMAGNETIC ANECHOIC CHAMBER

(71) Applicant: TEN-CHEN HO, Tu-Cheng (TW)

(72) Inventor: TEN-CHEN HO, Tu-Cheng (TW)

(21) Appl. No.: 13/660,050

(22) Filed: Oct. 25, 2012

(30) Foreign Application Priority Data
Dec. 12, 2011 (CN) 201110411726.0

(51) Int. Cl. H01Q 17/00

(52) U.S. Cl. 342/4

(57) ABSTRACT

An electromagnetic anechoic chamber includes a peripheral wall and a bottom wall. The peripheral wall is covered with wave absorbers on the inner surface thereof. The bottom wall is circular, and covered by the peripheral wall, and divided into two semicircles, one half is a reflecting ground floor, and forms a semi-anechoic chamber with the peripheral wall thereon; the other half is covered with wave absorbers, and forms a fully anechoic chamber with the peripheral wall thereon.

### BACKGROUND

1. Technical Field

The present disclosure relates to electromagnetic compatibility (EMC) test, and particularly to an electromagnetic anechoic chamber for EMC test.

2. Description of Related Art

An electromagnetic anechoic chamber is needed as an EMC field test. The electromagnetic anechoic chamber includes a fully anechoic chamber and a semi-anechoic chamber. The inner surface of the fully anechoic chamber is completely covered with wave absorbers, the inner surface of the semi-anechoic chamber is partly covered with wave absorbers. The electromagnetic anechoic chamber is for testing the EMC of various kinds of information technology equipment (ITEs), such as personal computers, liquid crystal displays, and mobile phones. The semi-anechoic chamber is for ITEs low frequency test, while the fully anechoic chamber is for ITEs high frequency test. However, physically moving the ITEs between the semi-anechoic chamber and fully anechoic chamber for the different frequency tests is time-consuming and inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, partial cutaway, and isometric view of an exemplary embodiment of an electromagnetic anechoic chamber.

FIG. 2 is a front-on view of the electromagnetic anechoic chamber shown in FIG. 1.

FIG. 3 is a plan view of the electromagnetic anechoic chamber shown in FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one”.

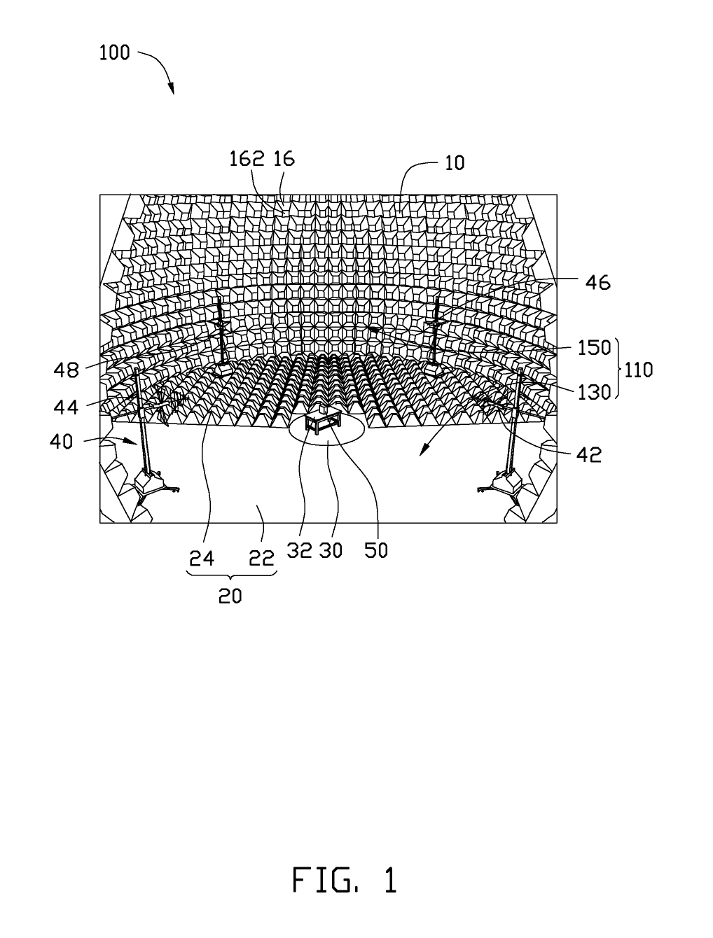

FIG. 1 is a partial view of an exemplary embodiment of an electromagnetic anechoic chamber 100. The electromagnetic anechoic chamber 100 can be used for testing of electromagnetic radiation generated by items of information technology equipment (ITE), such as personal computers, liquid crystal displays, and mobile telephones (electromagnetic compatibility (EMC) testing). The electromagnetic anechoic chamber 100 includes a peripheral wall 10, a bottom wall 20, a rotating platform 30, and an antenna array 40.

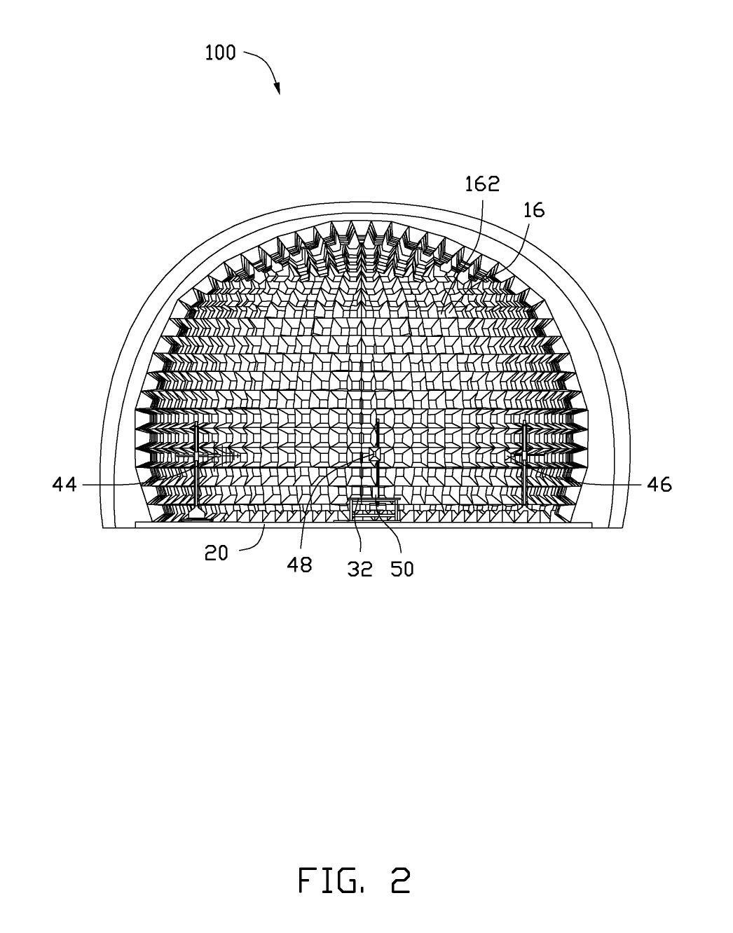

FIG. 2 is a front-on view of the electromagnetic anechoic chamber 100 shown in FIG. 1. Referring to FIG. 1 and FIG. 2, the peripheral wall 10 is partially spherical, which is covered on the bottom wall 20, and a closed partially spherical-shaped receiving space 110 is formed. The inner surface of the peripheral wall 10 is covered with pyramidal wave absorbers 16. Each wave absorber has a narrow leading surface 162 for absorbing electromagnetic waves. The leading surfaces 162 face radially inwards from the peripheral wall 10, and is radially aligned with the receiving space 110.

The bottom wall 20 is circular and is divided into two equal parts. One part of the bottom wall 20 is a reflective floor electrically connected to ground (the first bottom wall 22) and the other part of the bottom wall 20 is covered with pyramidal wave absorbers 16 (the second bottom wall 24). The electromagnetic anechoic chamber 100 is thus divided in two, one half is a semi-anechoic chamber 130 formed by the first bottom wall 22 and the peripheral wall 10 above the first bottom wall 22, the other half is a fully anechoic chamber 150 formed by the second bottom wall 24 and the peripheral wall 10 above the second bottom wall 24.

The rotating platform 30 is located at the center of the circular bottom wall 20. The rotating platform 30 supports a test bench 32 thereon, and the test bench 32 supports equipment under test (EUT 50). The rotating platform 30 is used to rotate the EUT 50 for alternately facing the EUT 50 at different portions of the antenna array 40. The EUT 50 is the electromagnetic radiation source in an EMC test, the EUT 50 can be items of information technology equipment, such as personal computers, liquid crystal displays, and mobile telephones. The EUT 50 is supported by the test bench 32 above the bottom wall 20 at a predetermined height.

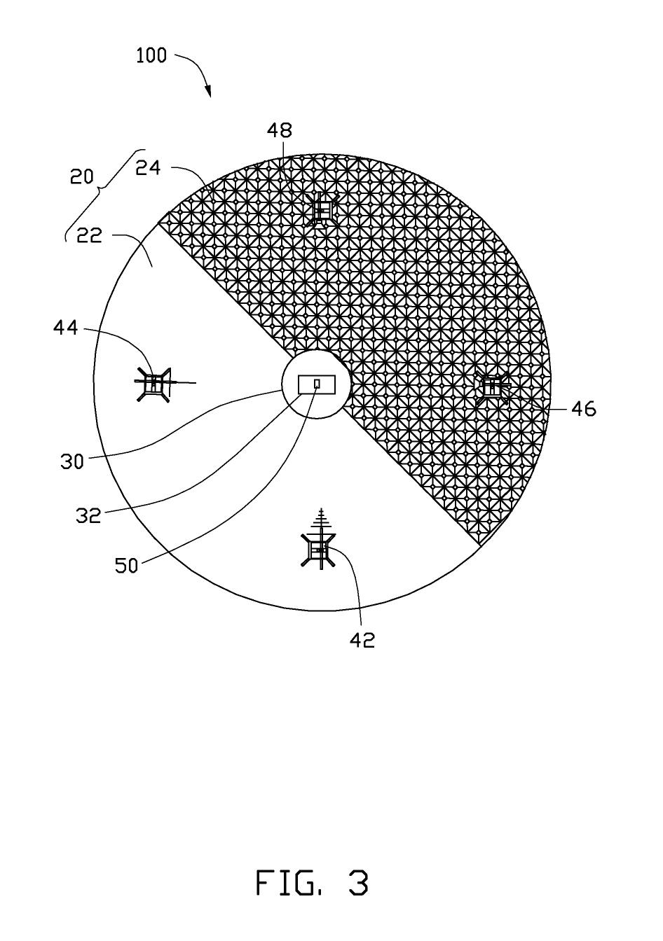

FIG. 3 is a plan view of the electromagnetic anechoic chamber 100 shown in FIG. 1. Referring to FIG. 1 and FIG. 3, the antenna array 40 includes a low frequency horizontal antenna 42, a low frequency vertical antenna 44, a high frequency horizontal antenna 46 and a high frequency vertical antenna 48. The plurality of antennas 42, 44, 46, and 48 are distanced from each other and positioned in proximity to the edge of the circular bottom wall 20. In particular, the antennas 42, 44, 46, and 48 are located at opposite ends of perpendicular diameters of bottom wall 20. Furthermore, the low frequency horizontal antenna 42 and the low frequency vertical antenna 44 are located on the first bottom wall 22, in the semi-anechoic chamber 130. The high frequency horizontal antenna 46 and the high frequency vertical antenna 48 are located on the second bottom wall 24, in the fully anechoic chamber 150. The antenna array 40 is spaced apart from the EUT 50, and the antenna array 40 is oriented directly at the EUT 50.

The leading surface 162 of each pyramidal wave absorber 16 of the peripheral wall 10 points at the EUT 50. When the EUT 50 is working, the EUT 50 generates some noise and electromagnetic waves which are not needed in the EMC test. Such noise and unwanted electromagnetic waves radiate to the peripheral wall 10, and the pyramidal wave absorbers 16 completely absorb the noise and the electromagnetic waves, to avoid interference caused by reflections from the peripheral wall 10.

When using the electromagnetic anechoic chamber 100 for an EMC test, the EUT 50 must transmit in the low frequency band (e.g. 30 MHz-1 GHz) and in the high frequency band (e.g. 1 GHz-6 GHz), and in each frequency band, the antenna should be set separately in a vertical polarity and in a horizontal polarity. In the present embodiment, the low frequency horizontal antenna 42 is used in the low frequency band test first. The EUT 50 is switched on, and a receiver (not shown) is connected to the low frequency horizontal antenna 42. The low frequency horizontal antenna 42 receives the signals generated by the EUT 50, then transforms the signal to electrical signal and passes to the receiver. The receiver reads the electrical signal and measures the strength of the signal radiated by the EUT 50. After that, the receiver can be connected to the low frequency vertical antenna 44, to the high frequency horizontal antenna 46, and to the high frequency vertical antenna 48 in turn, so that the antenna array 40 functions with vertical polarity in the low frequency band, then with horizontal polarity in the high frequency band and then with vertical polarity in the high frequency band, to finish the EMC test.

The distance between the two antennas is typically greater than 3 meters, to avoid any mutual coupling effect between two antennas, and maintain the accuracy of the EMC test.

The circular bottom wall 20 of the electromagnetic anechoic chamber 100 is divided into two equal parts, one part is a reflecting ground floor, the other part is covered with pyramidal wave absorbers 16, so that the electromagnetic anechoic chamber 100 can function as a semi-anechoic chamber and a fully anechoic chamber at the same time. The low frequency horizontal antenna 42 and the low frequency vertical antenna 44 are placed in the semi-anechoic chamber 130, and the high frequency horizontal antenna 46 and the high frequency vertical antenna 48 are present and functioning at the same time in the fully anechoic chamber 150, so that the electromagnetic anechoic chamber 100 applies the EMC test in the low frequency band and in the high frequency band, without the antenna being moved. Furthermore, the antenna array 40 includes the antennas at vertical polarity and horizontal polarity during the EMC test, the polarity of the antenna does not need to be changed, from vertical to horizontal, or from horizontal to vertical. Thus this EMC test saves time and human resources by not needing to change the antenna polarity or to move the antenna, and avoids any error caused by the changing of the antenna. The course of the test is very simple, and testing accuracy is improved.

Even though numerous characteristics and advantages of the embodiments have been set forth in the foregoing description, together with details of the structure and function of the embodiments, the present disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. An electromagnetic anechoic chamber, comprising:
a peripheral wall covered with wave absorbers on an inner surface thereof; and
a circular bottom wall, the bottom wall covered by the peripheral wall thereon and divided into two semicircles, one half of the bottom wall being a reflecting ground floor, and forming a semi-anechoic chamber with the peripheral wall; the other half of the bottom wall being covered with wave absorbers, and forming a fully anechoic chamber with the peripheral wall.

2. The electromagnetic anechoic chamber of claim 1, wherein the peripheral wall is at least partially spherical, which in combination with the bottom wall, forms a partially spherical-shaped closed receiving space.

3. The electromagnetic anechoic chamber of claim 1, further comprising:
a rotating platform located on a center of the circular bottom wall;
a test bench supported by the rotating platform thereon, which is used to support an Equipment Under Test (EUT) thereon; and
an antenna array positioned on an edge of the circular bottom wall.

4. The electromagnetic anechoic chamber of claim 3, wherein the antenna array comprises a low frequency horizontal antenna, a low frequency vertical antenna, a high frequency horizontal antenna, and a high frequency vertical antenna, the antennas are located at opposite ends of perpendicular diameters of bottom wall, and the receiving parts of the antennas are aimed at the EUT.

5. The electromagnetic anechoic chamber of claim 4, wherein the low frequency horizontal antenna and the low frequency vertical antenna are located in the semi-anechoic chamber, while the high frequency horizontal antenna and the high frequency vertical antenna are located in the fully anechoic chamber.

6. The electromagnetic anechoic chamber of claim 4, wherein the wave absorbers of the peripheral wall are pyramidal shape, a top end of each wave absorber forms a leading surface, and the leading surfaces are aimed at the EUT.

7. The electromagnetic anechoic chamber of claim 6, wherein the EUT can be an information technology equipment (ITE) which can generate electromagnetic wave.

8. The electromagnetic anechoic chamber of claim 1, wherein the electromagnetic anechoic chamber can be used to operate an electromagnetic compatibility (EMC) test.
